(19) United States
(12) Patent Application Publication
(10) Pub. No.: US 2017/0229898 A1
(43) Pub. Date: Aug. 10, 2017

(54) Charging Device

(71) Applicant: Quanta Computer Inc., Tao Yuan Shien (TW)

(72) Inventors: Pei-Heng Chen, Taoyuan City (TW); Hao-Ting Huang, Taoyuan City (TW)

(21) Appl. No.: 15/151,614

(22) Filed: May 11, 2016

(30) Foreign Application Priority Data
Feb. 4, 2016 (TW) 105103881

(51) Int. Cl. H02J 7/02; H02J 7/00

(52) U.S. Cl. CPC H02J 7/025; H02J 7/0052; H02J 7/027; H02J 2007/0062

(57) ABSTRACT

A charging device is provided. The charging device includes a charging box and a power bank. The charging box includes a first battery, a first control module, a wireless charging transmission module, and a first wired charging connection module. The power bank includes a second battery, a second control module, a wireless charging receiving module, and a second wired charging connection module. When the first wired charging connection module is electrically decoupled from the second wired charging connection module, the wireless charging transmission module is capable of delivering power to the wireless charging receiving module.

### CROSS-REFERENCE TO RELATED APPLICATION

This application claims priority from Taiwan Patent Application No. 105103881, filed on Feb. 4, 2016, in the Taiwan Intellectual Property Office, the content of which is hereby incorporated by reference in their entirety for all purposes.

### BACKGROUND OF THE INVENTION

1. Field of the Invention

The present invention relates to a charging device; in particular, the present invention relates to a charging device with the wireless charging function.

2. Description of the Related Art

In present days, mobile devices such as the smart watch and the smartphone is getting ubiquitous, such devices are capable of performing wireless communication as well as storing personalized information. As a result, people are getting dependent on such devices to carry out daily routines. With the dependency on mobile devices growing, the battery capacity therein becomes a major concern for the users as well as the device manufacturers.

For instance, a user has to charge the smartphone or the smartwatch at least on daily basis. On top of that, the battery capacity inside the smart watches and the smartphones will dwindle due to aging. Under the circumstances, a power bank is required as a form of backup power supply.

The lithium-ion battery or nickel-metal hydride batteries can usually be found in a power bank. Understandably, such batteries are rechargeable so that a user is able to recharge the power bank with such batteries when the power therein has depleted. Apart from that, the power bank is usually recharged daily since a typical user has several mobile devices relying on the power supply of power bank.

### SUMMARY OF THE INVENTION

The objective of the present invention is to provide a charging device.

In accordance with an embodiment of the present invention, a charging device includes a charging box and a power bank. The charging box includes a first battery, a first control module, a wireless charging transmission module, and a first wired charging connection module. The first control module is electrically coupled to the first battery. The first wired charging connection module is electrically coupled to the first control module and the first battery. The power bank includes a second battery, a second control module, a wireless charging receiving module, and a second wired charging connection module. The second control module is electrically coupled to the second battery. The wireless charging receiving module is electrically coupled to the second battery. The second wired charging connection module is electrically coupled to the second control module and the second battery; wherein the first wired charging connection module may be selectively electrically coupled to or electrically decoupled from the second wired charging connection module. When the first wired charging connection module is electrically decoupled from the second wired charging connection module, the wireless charging transmission module is capable of delivering power to the wireless charging receiving module.

The charging device of the aforementioned embodiments is able to provide continuous charging to the mobile device whether the first wired charging connection module and the second wired charging connection module are connected or not. Therefore, the battery life of mobile devices can be prolonged to provide user with access to the device whenever it is necessary.

### BRIEF DESCRIPTION OF THE DRAWINGS

FIG. 1 is the three dimensional view of the charging device and portable electronic device according to an embodiment of the present invention.

FIG. 2 is the block diagram illustrating the circuitry of the charging box according to an embodiment of the present invention.

FIG. 3 is a block diagram illustrating the circuitry of the power bank according to an embodiment of the present invention.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

It will also be understood that when an element is referred to as being “connected to” or “coupled to” another element, it can be directly connected or coupled to the other element or intervening elements may be present. In contrast, when an element is referred to as being “directly connected” or “directly coupled” to another element, there is no intervening element present.

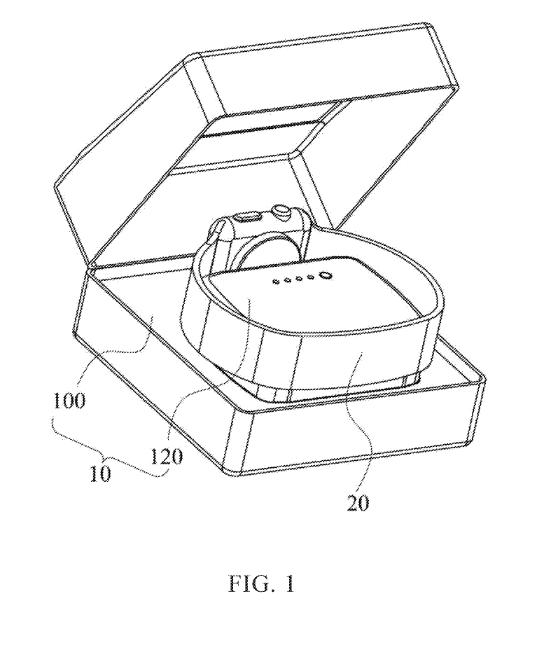

FIG. 1 is the three dimensional view of the charging device 10 and portable electronic device 20 according to an embodiment of the present invention. As can be appreciated in FIG. 1, charging device 10 includes the charging box 100 and the power bank 120. In FIG. 1, the portable electronic device 20 is disposed in the charging device 10 so that the charging device 10 can charge up the portable electronic device 20. It is understood that the portable electronic device 20 in FIG. 1 only exemplified by a smartwatch, but the present invention is not limited thereto. In other embodiments, the portable electronic device 20 could be a smartphone.

In a practical embodiment, the portable electronic device 20 is not necessarily disposed in the charging device 10; instead the portable electronic device 20 may be connected to the charging device 10 by a transmission cable or receive the power of the charging device 10 through wireless charging.

Hereinafter, the disclosure will further illustrate the block diagram for the circuitry of the charging box 100 and the power bank 120 in one or more embodiment of the present invention, as well as various charging modes of the charging box 100 and the power bank 120.

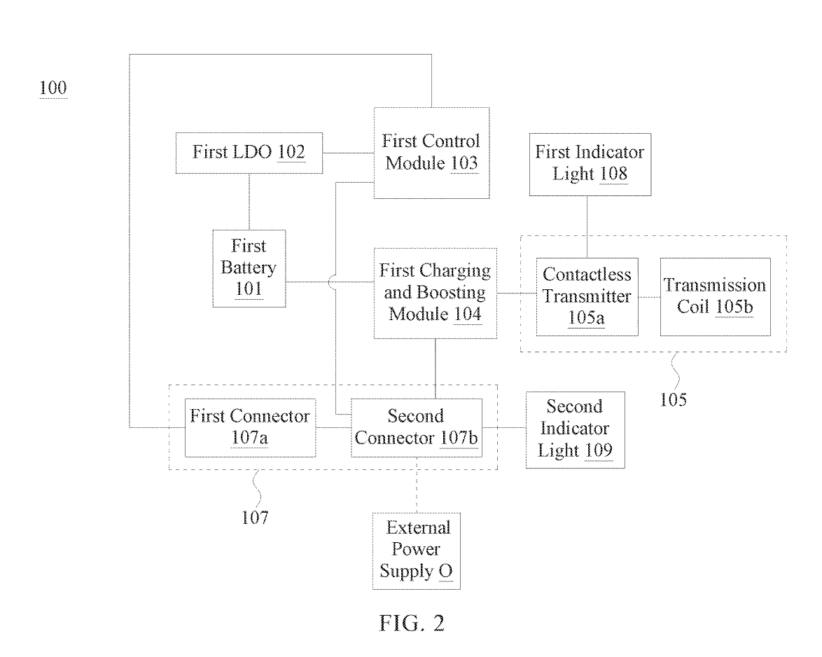

FIG. 2 is the block diagram illustrating the circuitry of the charging box 100 according to an embodiment of the present invention. Charging box 100 includes a first battery 101, a first control module 103, wireless charging transmission module 105 and a first wired charging connection module 107. The first control module 103 is electrically connected to the first battery 101. The wireless charging transmission module 105 is electrically connected to the first battery 101. The first wired charging connection module 107 is electrically coupled to the first control module 103 and the first battery 101.

In an embodiment, the first wired charging connection module 107 may further include the first connector 107a and the second connector 107b, wherein the first connector 107a is electrically coupled to the second connector 107b. Furthermore, the first connector 107a may connect the power bank 120 to deliver power thereto. The second connector 107b may connect the external power supply O. Besides, the second connector 107b may be electrically coupled to the first control module 103, which detects whether the second connector 107b is connected to the external power supply O. Practically speaking, both the first connector 107a and the second connector 107b could be the Universal Serial Bus (USB) connector such as the Micro USB, or the PCI Express, but the present invention is not limited thereto. In other embodiments, different types of connectors may be implemented as the first connector 107a and the second connector 107b which are not necessarily limited to the USB connector. Apart from that, the external power supply O may implemented in the form of a household power socket or the connector of other electronic devices capable of delivering power, e.g. the USB connector.

In an embodiment, the charging box 100 may further include the first charging and boosting module 104, whereas the first control module 103, wireless charging transmission module 105 and the first wired charging connection module 107 are electrically coupled to the first battery 101 through the first charging and boosting module 104. Precisely, the first charging and boosting module 104 is electrically coupled to the first battery 101, first control module 103, wireless charging transmission module 105 and the first wired charging connection module 107. When the second connector 107b in the first wired charging connection module 107 receives the external power supply O, the first charging and boosting module 104 is applied to provide an appropriate amount of charging voltage and charging current to the first battery 101. Apart from that, when the wireless charging transmission module 105 is to deliver power to an external portable electronic device wirelessly, the first charging and boosting module 104 may boost the discharge voltage of the first battery 101 to provide the wireless charging transmission module 105 with adequate power to emit electromagnetic wave.

In an embodiment, the wireless charging transmission module 105 may further include the contactless transmitter 105a and the transmission coil 105b, wherein the contactless transmitter 105a electrically couples the first charging and boosting module 104, the transmission coil 105b electrically couples the contactless transmitter 105a. In another embodiment, the charging box 100 may further include a first indicator light 108. When the charging box 100 delivers power through the wireless charging transmission module 105, the first indicator light 108 may glow to remind the user that the wireless power transmission is on. In yet another embodiment, the charging box 100 may further include a second indicator light 109. The second indicator light 109 is electrically coupled to the second connector 107b. When the second connector 107b is receiving power from the external power supply O, the second indicator light 109 may glow to remind the user that the second connector 107b is delivering power.

In an embodiment, the charging box 100 may include the first Low-Dropout linear regulator (LDO) 102, which is electrically connected between the first battery 101 and the first control module 103. The first LDO 102 converts the voltage from the first battery 101 which in higher into a lower and stable output voltage and delivers the voltage to the first control module 103.

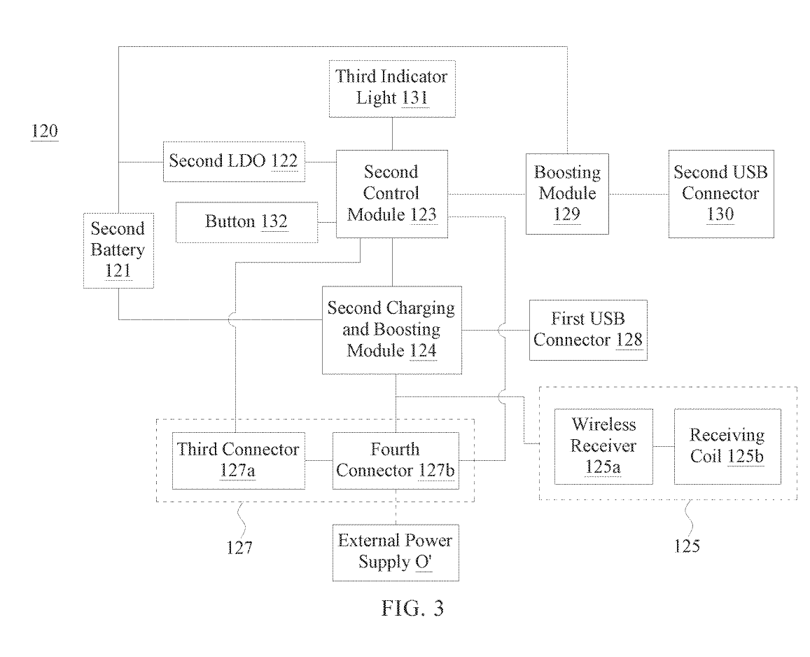

FIG. 3 is a block diagram illustrating the circuitry of the power bank 120 according to an embodiment of the present invention. As shown in the figure, the power bank 120 includes a second battery 121, a second control module 123, a wireless charging receiving module 125 and a second wired charging connection module 127. The second control module 123 is electrically coupled to the second battery 121. The wireless charging receiving module 125 is electrically connected to the second battery 121. The second wired charging connection module 127 is electrically coupled to the second control module 123 and the second battery 121.

In an embodiment, the second wired charging connection module 127 may further include a third connector 127a electrically coupled to a fourth connector 127b. Precisely, when the power bank 120 is disposed on the charging box 100, the third connector 127a may be coupled to the first connector 107a of the charging box 100 in order to receive the power from the charging box 100. Besides, the fourth connector 127b may connect to the external power supply O′ as well, in order to receive the power from the external power supply O′ directly. Apart from that, the fourth connector 127b may be electrically coupled to the second control module 123 which would detect whether the fourth connector 127b is connected to the external power supply O′. In practical implementation, both the third connector 127a and the fourth connector 127b could come in the form of USB connectors such as the Micro USB, or in the form of PCI Express, but not limited thereto. In other embodiments, different types of connectors which are not limited to the USB connectors could be implemented as the third connector 127a and the fourth connector 127b.

In an embodiment, the power bank 120 may further include the second charging and boosting module 124. The second charging and boosting module 124 is electrically coupled to the second battery 121, second control module 123, wireless charging receiving module 125 and the second wired charging connection module 127. When the wireless charging receiving module 125 is receiving power from the wireless charging transmission module 105 or the second wired charging connection module 127 is receiving power from the first wired charging connection module 107, in order to charge the second battery 121, the second charging and boosting module 124 is engaged to deliver an appropriate amount of charging voltage and charging current to the second battery 121. Furthermore the power bank 120 may include a first USB connector 128 electrically coupled to the second charging and boosting module 124. The second charging and boosting module 124 is able to boost the discharge voltage of the second battery 121 when the first USB connector 128 is delivering power to an external portable electronic device.

In an embodiment, the power bank 120 may further include a boosting module 129 and a second USB connector 130. The boosting module 129 may be electrically coupled between the second battery 121 and the second USB connector 130. When the second USB connector 130 is going to deliver power to an external portable electronic device, the boosting module 129 may boost the discharge voltage of the second battery 121.

In an embodiment, the wireless charging receiving module 125 may further include a wireless receiver 125a and a receiving coil 125b, wherein the wireless receiver 125a is electrically coupled to the second charging and boosting module 124, the receiving coil 125b is electrically coupled to the wireless receiver 125a. The receiving coil 125b is able to receive the electromagnetic wave from the transmission coil 105b, which will be transformed to the induced current. The wireless receiver 125a receives the induced current and then the second charging and boosting module 124 transforms the induced current to an appropriate amount of charging current and charging voltage that will be delivered to the second battery 121.

In an embodiment, the power bank 120 may further include a third indicator light 131. The third indicator light 131 is electrically coupled to the second control module 123. When the first USB connector 128 or second USB connector 130 of the power bank 120 is delivering power to an external portable electronic device, the second control module 123 is capable of controlling the third indicator light 131 to glow in order to remind the user that the first USB connector 128 or second USB connector 130 is charging the portable electronic device.

In an embodiment, the power bank 120 may further include a button 132. The button 132 transmits a trigger signal to the second control module 123. The second control module 123 may control the second battery 121 to charge the portable electronic device via the first USB connector 128 or the second USB connector 130 in response to the trigger signal.

In an embodiment, the power bank 120 further includes a second LDO 122 electrically coupled between the second battery 121 and the second control module 123. The second LDO 122 may convert the higher output voltage if the second battery 121 to a lower and stable output voltage and delivers the voltage to the second control module 123.

In one or more aforementioned embodiments, both the first control module 103 and the second control module 123 could be Micro Controller Units (MCUs). The first, second, and third indicator light 108, 109, and 131 could be light emitting diodes, but not limited thereto.

One or more embodiments disclosed above illustrate the circuitry of the charging box 100 and the power bank 120 of the charging device 10. In the following discourse accompanied by the reference drawings FIGS. 1 to 3, various embodiments will be presented to illustrate the joint operation of the charging box 100 and the power bank 120 with or without the portable electronic device 20 as well as with the first and second wired charging connection module 107 and 127 selectively electrically coupled to each other or selectively electrically decoupled from each other.

### First Embodiment

Only the charging box 100 and power bank 120 are present, without the portable electronic device 20. There is wired connection between the power bank 120 and the charging box 100, i.e. the power bank 120 and charging box 100 are connected through the first and second wired charging connection module 107 and 127, while the charging box 100 is connected to the external power supply O.

Since the first wired charging connection module 107 of the charging box 100 is electrically coupled to the second wired charging connection module 127 of the power bank 120, the first control module 103 is able to control the first wired charging connection module 107 to charge the power bank 120, whereas the second control module 123 is able to control the second wired charging connection module 127 to receive power from the first wired charging connection module 107. In simple words, the power bank 120 has the priority over the charging box 100 to receive power from the external power supply O, in case the user has urgent need for the power bank 120.

Moreover, when the first wired charging connection module 107 is connected to the second wired charging connection module 127 and there is no portable electronic device 20, the first connector 107a in the first wired charging connection module 107 is electrically coupled to the third connector 127a in the second wired charging connection module 127. In this case, the first connector 107a of the first wired charging connection module 107 may transmit a first connection signal to the first control module 103, and in accordance with the first connection signal, the first control module 103 in turn control the second connector 107b to deliver the power from the external power supply O to the first connector 107a, then the first connector 107a delivers power to the power bank 120 to meet the priority of the power bank 120 to receive power.

Besides, when the third connector 127a is electrically coupled to the first connector 107a, the third connector 127a in the second wired charging connection module 127 may transmit a second connection signal to the second control module 123. In accordance with the second connection signal, the second control module 123 may control the third connector 127a in the second wired charging connection module 127 to receive power from the first connector 107a in the first wired charging connection module 107 and then deliver the power to the second battery 121. Hence, then charging device 10 of the present embodiment may charge the power bank 120 preferably, in case the user needs to utilize the power bank 120 at any time, for instance travelling.

At last, when the second battery 121 of the power bank 120 is fully charged, the second control module 123 may transmit a full-battery signal indicating the battery is fully charged to the first control module 103 via the third connector 127a and the first connector 107a. The first control module 103 may in turn control the second connector 107b to deliver power form the external power supply O to the first battery 101 in accordance with the full-battery signal.

### Second Embodiment

Only the charging box 100 and power bank 120 are present, without the portable electronic device 20. There is wired connection between the power bank 120 and the charging box 100; the charging box is not connected to the external power supply O.

In this case, in order to charge the power bank 120 which has the priority over the charging box 100 to be charged, the first battery 101 in the charging box 100 will deliver power to the power bank 120. Since there is wired connection between the power bank 120 and the charging box 100, the power bank 120 is capable of receiving power from the charging box 100 through the third connector 127a.

In the present embodiment, despite the wired connection between the power bank 120 and the charging box 100, the power bank 120 may also receive power from the charging box 100 through the wireless charging receiving module 125. In other words, the charging box 100 may selectively deliver power through wired or wireless connection depending on the actual settings of the present invention.

### Third Embodiment

The charging box 100 and power bank 120 are present, without the portable electronic device 20. There is no wired connection between the power bank 120 and the charging box 100, i.e. there is no physical connection between the first wired charging connection module 107 and the second wired charging connection module 127.

Under the circumstances, the charging box 100 would only charge the power bank 120 through wireless connection. In simple words, when the first wired charging connection module 107 is electrically decoupled from the second wired charging connection module 127, the wireless charging transmission module 105 may deliver power to the wireless charging receiving module 125, in order to charge the power bank 120 which has the priority over the charging box 100 to be fully charged.

### Fourth Embodiment

The portable electronic device 20 is connected to the power bank 120, for instance, connected through first USB connector 128 or second USB connector 130, and there is wired connection between the power bank 120 and the charging box 100; the charging box 100 is connected to the external power supply O.

Under the circumstances, the power bank 120 will start charging the portable electronic device 20 as soon as the user presses down the button 132 shown in FIG. 3. In an embodiment, if the power in the power bank 120 has depleted, the charging box 100 will start charging the power bank 120 instead. In this case, the power bank 120 will not charge the portable electronic device 20; however, if the user presses the button 132 while the charging box 100 is charging the power bank 120 and the battery level in the power bank 120 is adequate, the power bank 120 will start charging the portable electronic device 20 immediately and the charging box 100 will stop charging the power bank 120. This purpose of this design is to prevent the power bank 120 from charging and discharging simultaneously which may cause damage to the second battery 121. In yet another embodiment, if the battery in the power bank 120 has depleted but the portable electronic device 20 has the function of wireless power transmission and both the portable electronic device 20 and the charging box 100 possess compatible wireless charging protocol, the charging box 100 would perform wireless charging to the portable electronic device 20 as an alternative. In the meantime, in order to prevent the power bank 120 from interrupting wireless power transmission between the portable electronic device 20 and the charging box 100, the user may choose to remove the power bank 120.

In a nutshell, several exemplary embodiments and the working principle of the charging device are disclosed in the context herein. Basically, the power bank in the charging device will be charged preferably as long as the charging box is not charging the portable electronic device, such that there is power available in the power bank whenever the user desires. When a portable electronic device is disposed in the charging device, the electronic device will be given priority to be charged over the power bank once the user presses the button. Apart from that, the charging box in the present invention may possess the function of wired and wireless charging simultaneously, so the power bank can be charged whether the charging box is connected to the power supply or not.

In accordance with the embodiment of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

What is claimed is:

1. A charging device, comprising:
a charging box comprising:
a first battery;
a first control module electrically coupled to the first battery;
a wireless charging transmission module electrically coupled to the first battery; and
a first wired charging connection module electrically coupled to the first control module and the first battery; and
a power bank comprising:
a second battery;
a second control module electrically coupled to the second battery;
a wireless charging receiving module electrically coupled to the second battery; and
a second wired charging connection module electrically coupled to the second control module and the second battery, wherein the first wired charging connection module is configured to be selectively electrically coupled to or decoupled from the second wired charging connection module;
wherein, when the first wired charging connection module is electrically decoupled from the second wired charging connection module, the wireless charging transmission module is configured to deliver power to the wireless charging receiving module.

2. The charging device of claim 1, wherein, when the first wired charging connection module is electrically coupled to the second wired charging connection module are, the first control module is configured to control the first wired charging connection module to charge the power bank, and the second control module is configured to control the second wired charging connection module to receive power from the first wired charging connection module.

3. The charging device of claim 2, wherein, when the first wired charging connection module is electrically coupled to the second wired charging connection module, the first wired charging connection module is configured to transmit a first connection signal to the first control module; the first control module is configured to control the first wired charging connection module to deliver power according to the first connection signal.

4. The charging device of claim 2, wherein, when the first wired charging connection module is electrically coupled to the second wired charging connection module, the second wired charging connection module is configured to transmit a second connection signal to the second control module; the second control module is configured to control the second wired charging connection module to receive power according to the second connection signal

5. The charging device of claim 2, wherein when the charging box is connected to an external power supply, the power bank has a priority over the charging box to receive power from the external power supply.

6. The charging device of claim 5, wherein the power bank further comprises at least one Universal Serial Bus (USB) connector for connecting a portable electronic device.

7. The charging device of claim 6, wherein the power bank further comprises a button, the button is configured to deliver a trigger signal to the second control module, in response to the trigger signal the second control module is configured to control the second battery to charge the portable electronic device through the at least one USB connector.

8. The charging device of claim 1, wherein the first wired charging connection module comprises a first connector and a second connector; and the second wired charging connection module comprises a third connector and a fourth connector; wherein the first connector is selectively electrically coupled to or electrically decoupled from the third connector, the second connector and the fourth connector are capable of connecting the external power supply.

9. The charging device of claim 1, wherein the charging box further comprises a first Low-Dropout Linear Regulator (LDO) electrically coupled between the first battery and the first control module.

10. The charging device of claim 1, wherein the power bank further comprises a second LDO electrically coupled between the second battery and the second control module.
